(19) United States
(12) Patent Application Publication
(10) Pub. No.: US 2026/0356995 A1
(43) Pub. Date: Nov. 12, 2026

(54) Multi-Nodal Polymer Particles and a Micropowder Made Therefrom

(71) Applicant: Celanese International Corporation, Irving, TX (US)

(72) Inventors: Layane Deghedi, Illkirch-Graffenstaden (FR); Christian Ohm, Sulzbach (DE); Victoria Black, Cincinnati, OH (US); Argiri Tsami-Schulte, Kelkheim (DE); Dirk Flohrmann, Oberhusen (DE); Jonas Seidemann, Frankfurt am Main (DE); David Hettmann, Düsseldorf (DE)

(21) Appl. No.: 19/674,375

(22) Filed: May 12, 2026

Related U.S. Application Data
(60) Provisional application No. 63/804,005, filed on May 12, 2025.
(60) Provisional application No. 63/910,327, filed on Nov. 3, 2025.
(60) Provisional application No. 63/911,027, filed on Nov. 4, 2025.

(51) Int. Cl. C08F 10/02; C10M 143/02; C10N 20/06; H01M 4/62; H01M 50/417; H01M 50/443; H01M 50/491

(52) U.S. Cl. CPC C08F 10/02; C10M 143/02; H01M 4/622; H01M 50/417; H01M 50/443; H01M 50/491; C10M 2205/022; C10N 2020/06

(57) ABSTRACT

A polymer micropowder is disclosed made from a high density polyethylene polymer. In one aspect, the polymer micropowder is produced through a grinding process. The high density polyethylene particles, for instance, can initially have a multi-nodal shape that includes nodes that are broken off during the grinding process to produce the micropowder.

### BACKGROUND

Polyethylene polymers have numerous and diverse uses in many different fields of applications. For example, high density polyethylene polymers, including high molecular weight and ultrahigh molecular weight polyethylene polymers, are valuable engineering plastics with a unique combination of abrasion resistance, surface lubricity, chemical resistance, and impact strength.

High density polyethylene polymers are commercially available in different grades that vary by molecular weight and/or particle size. In the past, particle sizes have typically ranged from about 20 microns to about 500 microns or larger.

Recently, those skilled in the art have attempted to produce high molecular weight polyethylene particles having particle sizes of smaller than about 25 microns. For instance, Mitsui Chemicals recently began marketing an ultrahigh molecular weight polyethylene powder having a particle size of from 10 microns to about 65 microns under the name MIPELON polymer additive. In addition, JP 2011-80013, which is incorporated herein by reference, discloses a process for producing ultrahigh molecular weight polyethylene particles having a fine particle size. As disclosed in the JP '013 application, the polyethylene particles are produced using a complex polymer catalyst that forms particles having a smooth spherical shape. The particles, however, are not only expensive to produce but have a morphology that is not well suited to many different applications.

In view of the above, a need exists for very fine high density polyethylene particles that have improved characteristics and properties that make them well suited for use in various polymer processes. A need also exists for an economical and efficient way of producing fine particles with a desired morphology and particle size distribution.

### SUMMARY

The present disclosure is generally directed to high density polyethylene particles having a multi-nodal or “super-nodal” configuration and to a polymer micropowder made from the multi-nodal particles. In one aspect, for instance, the present disclosure is directed to producing multi-nodal high density polyethylene particles that are then ground to form a polymer micropowder containing particles having not only an extremely small size but also having a desirable morphology and physical properties that make the particles well suited for use in numerous applications.

For instance, the micropowders of the present disclosure are particularly well suited for producing gel extruded articles, such as porous membranes for use in ion batteries. The micropowder is also well suited for use as a binder in producing electrodes in energy storage devices. In addition, the micropowder is well suited for producing porous sintered structures or articles. The sintered structures can have a small pore size. The polymer micropowder of the present disclosure is also well suited for replacing fluoropolymers, such as polytetrafluoroethylene polymers, in various and different applications. For instance, the polymer micropowder can be incorporated into various lubricant compositions, such as oils and greases. The polymer micropowder is also an excellent wear additive and can be compounded with various thermoplastic polymers to improve wear and/or lower surface friction.

In one embodiment, for instance, the present disclosure is directed to a polymer micropowder comprising polymer particles having a median particle size (D50) of less than about 9.5 microns, such as less than about 9 microns. The median particle size (D50) is generally greater than about 0.5 microns, such as greater than about 1 micron. The polymer particles can also display a 10th percentile particle size of from about 0.5 microns to about 3 microns, such as from about 1.5 microns to about 2.5 microns. The polymer particles can display a 90^{th} percentile particle size of from about 12 microns to about 25 microns, such as from about 12 microns to about 22 microns, such as from about 12 microns to about 19 microns.

The polymer particles comprise a high density polyethylene polymer. The high density polyethylene polymer can have an average molecular weight of greater than about 200,000 g/mol, such as greater than about 500,000 g/mol, such as greater than about 650,000 g/mol, such as greater than about 800,000 g/mol, such as greater than about 1,000,000 g/mol, such as greater than about 1,200,000 g/mol, such as greater than about 1,500,000 g/mol, such as greater than about 1,700,000 g/mol, such as greater than about 1,900,000 g/mol, and less than about 13,000,000 g/mol.

The polymer micropowder of the present disclosure not only has a relatively small particle size but can optionally be formed with a relatively low bulk density. For instance, the polymer particles can display a bulk density of less than about 0.39 g/cm³ when tested according to ISO Test 60.

In one aspect, the polymer particles can comprise ground particles. For instance, in one embodiment, high density polyethylene particles having a multilobal shape comprising a network of nodes can be ground. The resulting polymer particles can comprise remnants of the nodes that have been separated from the multilobal-shaped polymer particles. In one aspect, the polyethylene polymer contained in the particles is not crosslinked.

The high density polyethylene polymer contained within the polymer particles can display a relatively high melting temperature or a low melting temperature. In one aspect, the high density polyethylene polymer can have a melting temperature of greater than about 135.5 °C, such as greater than about 137 °C. Alternatively, the high density polyethylene polymer can have a melting temperature of less than about 135.5 °C, such as less than about 135.1 °C.

The present disclosure is also directed to molded articles made from the polymer micropowder as described above. In one aspect, the molded article can be made through a gel extrusion process. The molded article, for instance, can comprise a porous membrane well suited for use as a separator between an anode and a cathode in an ion battery, such as a lithium ion battery or a sodium ion battery. The porous membrane can be formed to have a porosity of from about 25% to about 60% and a Gurley permeability of from about 50 sec/100 mL to about 500 sec/100 mL. The porous membrane can have a thickness of from about 3 microns to about 25 microns, such as from about 4 microns to about 12 microns.

The polymer micropowder of the present disclosure can also be used as a binder to produce electrodes for energy storage devices. In one aspect, for instance, the electrode can be a film comprising a network of an active material held together by the binder. The film can be formed through heat and pressure. The active material can comprise a material capable of producing metal ions or can comprise a material containing carbon, such as graphite. The electrode, for instance, can serve as a cathode or an anode.

In one embodiment, for instance, the present disclosure is directed to an electrode comprising a film. The film comprises a network of an active material held together by a binder. The binder comprises polymer particles. The polymer particles comprise a high density polyethylene polymer having an average molecular weight of greater than about 200,000 g/mol. The polymer particles can comprise ground particles. At least some of the high density polyethylene particles contained in the film can have a particle size of from about 0.5 microns to about 10 microns, such as from about 0.5 microns to about 5 microns, such as from about 1 micron to about 3 microns. The high density polyethylene particles can appear on a surface of the film at a density of from about 10 particles per 100 microns² to about 200 particles per 100 microns², such as from about 30 particles per 100 microns² to about 100 particles per 100 microns².

In one aspect, the present disclosure is also directed to adding the above particles to a polymer for forming a compounded polymer composition comprising a thermoplastic polymer. The thermoplastic polymer can be present in the polymer composition in an amount of greater than about 40% by weight. The thermoplastic polymer, for instance, can comprise a polyoxymethylene polymer, a polyester polymer, a polyamide polymer, a liquid crystal polymer, a polyphenylene sulfide polymer, a polyolefin polymer, or mixtures thereof. The polymer composition further contains a wear-reducing agent. The wear-reducing agent can comprise the polymer micropowder as described above.

The present disclosure is also directed to a lubricant composition comprising a lubricating matrix made from a base oil or grease. The lubricant composition further comprises a polymer micropowder as described above. The polymer micropowder can be present in the lubricant composition in an amount from about 0.01% by weight to about 10% by weight, such as in an amount from about 0.1% by weight to about 5% by weight, such as in an amount from about 0.5% by weight to about 2% by weight.

As described above, the polymer micropowder of the present disclosure can be formed from larger multi-nodal particles that are ground to produce the micropowder. In one aspect, the larger high density polyethylene particles have a super-nodal configuration.

In this regard, the present disclosure is also directed to a high density polyethylene particle composition comprising high density polyethylene particles having a multi-nodal configuration. The high density polyethylene particles can have a median particle size (D50) of from about 20 microns to about 500 microns, such as from about 40 microns to about 250 microns, such as from about 50 microns to about 180 microns. The nodes on the surface of each polyethylene particle can have an average nodule size of from about 0.5 microns to about 5 microns, such as from about 2 microns to about 5 microns. In one aspect, all of the nodes on the surface of each particle have a nodule size of less than about 15 microns, such as less than about 10 microns.

The high density polyethylene polymer used to produce the multi-nodal particles can vary in molecular weight. In one aspect, for instance, the high density polyethylene polymer can have an average molecular weight of from about 200,000 g/mol to about 800,000 g/mol. Alternatively, the average molecular weight can be from about 800,000 g/mol to about 2,200,000 g/mol. In another embodiment, the average molecular weight of the high density polyethylene polymer can be from about 2,200,000 g/mol to about 12,000,000 g/mol, such as from about 2,200,000 g/mol to about 6,000,000 g/mol.

The multi-nodal high density polyethylene particles as described above can be ground to produce a polymer micropowder in accordance with the present disclosure. The multi-nodal high density polyethylene polymer particles are relatively easy to grind and do not require any pre- or post-processing steps. For instance, it is not necessary to crosslink the high density polyethylene polymer prior to grinding.

The present disclosure is also directed to a process for producing a polymer micropowder. The process can include grinding high density polyethylene particles to form the polymer micropowder. The high density polyethylene particles can have a multilobal shape comprising a network of nodes attached together as described above. During grinding, the nodes can be separated from the multilobal-shaped particles for forming the micropowder. The resulting micropowder can have a median particle size (D50) of less than about 9.5 microns.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a plan view of a popcorn-like high density polyethylene particle;

FIG. 2 is a plan view of a high density polyethylene particle having a multi-nodal or super-nodal configuration in accordance with the present disclosure;

FIG. 3 is a cross-sectional view of an energy storage device illustrating a first electrode or cathode spaced from a second electrode or anode and separated by a porous membrane or separator;

FIG. 4 is a side view of one embodiment of a process for forming an electrode film in accordance with the present disclosure;

FIG. 5 is a graphical representation of some of the results obtained in the examples below;

FIG. 6 is a plan view of one embodiment of an electrode film made in accordance with the present disclosure.

Repeat use of reference characters in the present specification and drawings is intended to represent the same or analogous features or elements of the present invention.

### DEFINITIONS

The melt flow rate of a polymer or polymer composition is measured according to ISO Test 1133 at 190 °C and at a load of 21.6 kg.

The density of a polymer is measured according to ISO Test 1183 in units of g/cm³.

Average particle size (d50) is measured using laser diffraction/light scattering, such as a suitable Horiba light scattering device.

The average molecular weight of a polymer is determined using the Margolies' equation. Molecular weight can be determined by first measuring the viscosity number according to DIN EN ISO Test 1628. Dry powder flow is measured using a 25 mm nozzle.

Tensile modulus, tensile stress at yield, tensile strain at yield, tensile stress at 50% break, tensile stress at break, and tensile nominal strain at break are all measured according to ISO Test 527-2/1B.

The full width at half maximum of a melting endothermic peak of a sample is measured with a differential scanning calorimeter (DSC). An electronic balance is used to measure 8.4 g of a sample. The sample is placed in an aluminum sample pan. An aluminum cover is attached to the pan, which is set in the differential scanning calorimeter. The sample and a reference sample are retained at 40 °C for one minute while nitrogen purge is performed at a flow rate of 20 mL/min then heated from 40 °C to 180 °C at a heating rate of 10 °C/min, retained at 180 °C for 5 minutes, and then cooled to 40 °C at a cooling rate of 10 °C/min. A baseline is drawn from 60 °C to 150 °C in the melting curve acquired during the process and the full width at half maximum of a melting endothermic peak is derived using analysis software, such as “Pyris Software (Version 7).” The test can be conducted using a DSC Q2000 calorimeter available from TA Instruments.

The half-crystallization period of time during an isothermal crystallization at 123 °C can be determined from the time that requires a quantity of heat measured during an isothermal crystallization measurement at 123 °C to correspond to the half of the peak area in differential scanning calorimetry (DSC) measurement. The test can be conducted using a DSC Q2000 calorimeter available from TA Instruments.

Contact angle measurements are performed on a Krüss DSA 100 instrument. A membrane sample (10×40 mm) is attached to a microscope slide using double sided adhesive tape. Static charging is dissipated by moving the prepared sample several times through a U-electrode static discharger. The sample is mounted in a measurement device and a 3.5 μl droplet of testing fluid (water or ethyleneglycol) is placed on the membrane. The contact angle is determined through the software for 7 seconds (one measurement per second) after placement of the droplet. These 7 data points are averaged to yield the contact angle at the point of measurement. Every sample is measured at 6 different spots or locations on each side and all results are averaged to the reported value.

A soaking test may be used to determine the wicking characteristics of membranes made in accordance with the present disclosure according to the following procedure.

For the soaking test a glass vessel is used with following dimensions: 20×10 cm upper area (covered with a metal plate)/19×8 cm lower area (base)/height: 10 cm). Two filter papers are sticked at the inside of the glass vessel with a tape. 300 ml propylene carbonate is filled into the vessel afterwards (fluid level: 2 cm). The vessel is covered with a metal plate and propylene carbonate is allowed to fill the gas space for 20 minutes.

Membranes are cut with scissors into pieces (length: 70 mm, width: 7 mm). This is done with nitrile gloves to prevent touching the membranes with the bare hand. The pieces are mounted on an anodized metal plate (140 mm×70 mm, frame width: 10 mm, slope: 80°) with the help of magnets. The MD direction of membranes shows upwards (=soaking direction).

The metal frame with the fixed membranes are then moved 40 times through a deionizer to remove electrostatic charges. After that the frame is placed into the vessel filled with propylene carbonate at room temperature and soaking of the membranes with propylene carbonates takes place for a desired time. During soaking takes place the vessel is closed with a metal plate. The different soaking distances of the membranes are measured every 30 minutes by taking a photo and measuring the distance with a suitable computer program.

Soaking distances of tested membranes is compared to draw conclusion on their battery electrolyte affinity.

Gurley permeability can be measured according to the Gurley Test, using a Gurley permeability tester, such as Gurley Densometer, Model KRK 2060c commercially available from Kumagai Riki Kogyo Co., LTD. The test is conducted according to ISO Test 5636. The Gurley Test measures air permeability as a function of the time required for a specified amount of air to pass through a specified area under a specified pressure. The units are reported in see/100 ml.

Porosity (%) is measured according to the following procedure. During the procedure, the following ASTM Standards are used as a reference: D622 Standard Test Method for Apparent Density of Rigid Cellular Plastics1; and D729 Standard Test Methods for Density and Specific Gravity (Relative Density) of Plastics by Displacement1. The following instruments are used: Calibrated Analytical Balance (0.0001 grams); Lorentzen & Wettre Micrometer, code 251(0.1 μm); and Deli 2056 art knife.

### Procedure:

### 1.1. Samples and Sample Preparation

Using the specimen art knife, cut each sample material into a minimum of three 60 mm±0.5 by 60 mm±0.5 specimens

1.2. Instrument and measurement
3.2.1 Using the L&W micrometer, take five readings of the thickness at each 60 mm by 60 mm specimen (average of 5 readings). Record this value as the thickness of this specimen.
3.2.2 Weigh the specimen directly on the balance. Record this value as the weight of this specimen.
3.2.3 The three specimens of the same sample are placed together and steps
3.2.1 and 3.2.2 are repeated to obtain the thickness and the weight.

Calculate the density to three significant figures as follows

$$a . Dfilm = Density ( film ) = \frac{Wt . of Specimen}{THK * Square}$$

$$Dfilm = density of specimen , ( mg / mm 3 )$$

$$Wt = weight of specimen , ( mg )$$

$$THK = thickness of specimen , ( mm )$$

$$Square = area of specimen , ( mm 2 )$$

$$b . Dpolymer = Density ( polymer ) 0.95 ( g / cm 3 )$$

$$Dpolymer : Density of raw materials , without the pores .$$

$$c . Porosity = ( 1 - Dfilm / Dpolymer ) * 100 \%$$

As used herein, puncture strength is measured according to ASTM Test D3763 and measures the ability of a membrane to withstand a foreign particle from causing a hole or defect. The test is conducted on a testing device, such as an Instron CEAST 9340 device. The drop height is 0.03 to 1.10 m. The impact velocity is 0.77 to 4.65 m/s. The maximum dropping mass is 37.5 kg and the maximum potential energy is 405 J. Puncture strength is measured in slow speed puncture mode at 1.67 mm/s. Puncture strength can be normalized by dividing by the thickness of the membrane resulting in units of mN/micron.

Heat shrinkage of a membrane is determined by putting a piece of membrane (3 in×3 in) in an oven at 105 °C for 1 h. Shrinkage is calculated by measuring the size in MD and TD direction before and after heat treatment.

As used herein, bulk density is measured according to DIN 53466.

As used herein, particle size is measured utilizing a laser defraction method according to ISO Test 13320.

As used herein, the size of nodules on the surface of a high density polyethylene particle (prior to grinding) is done using an SEM microscope at a magnification sufficient so that nodule sizes can be determined manually. At least 100 nodules are counted in order to establish an average nodule size and a nodule size distribution.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a polymer micropowder comprised of high density polyethylene polymer particles. The polyethylene polymer particles can be made from a high molecular weight polyethylene polymer or an ultrahigh molecular weight polyethylene polymer. In one aspect, the polymer micropowder is formed through grinding larger high density polyethylene particles. In one aspect, the particles being ground can have a multilobal shape and can comprise a network of nodes attached together. During grinding, the nodes become separated from the particle forming the micropowder. The resulting micropowder, for instance, can have a median particle size (D50) of less than about 25 microns, such as less than about 20 microns, such as less than about 15 microns, such as less than about 13 microns, such as less than about 11 microns, such as less than about 9.5 microns, such as less than about 9 microns.

In accordance with the present disclosure, the high density polyethylene particles that are ground to form the micropowder are produced under conditions that form a multi-nodal or “super-nodal” configuration. The high density polyethylene multi-nodal particles that are used to make the micropowder can include surface nodules having an extremely small size. For example, in one aspect, the nodes on the surface of the particles can have an average nodule size of less than about 6 microns. In the past, various problems have been encountered in attempting to grind high density polyethylene particles into a micropowder. High density polyethylene, for instance, is known to be a very resistant material to abrasion. In order to grind these particles in the past, the polymer in the particles were either crosslinked or a grinding aid was used. The high density polyethylene multi-nodal particles of the present disclosure, on the other hand, have been found to grind more efficiently into smaller-sized particles. For instance, the high density polyethylene multi-nodal particles can be ground using a jet mill without having to crosslink the polymer and/or without adding a grinding aid to the jet mill. It was discovered that the particles can be ground at a much higher throughput and can produce a much larger amount of smaller particles having the desired size and morphology.

The polymer micropowder of the present disclosure derived from the multi-nodal high density polyethylene particles can offer numerous advantages and benefits. For instance, the polymer micropowder can optionally have a relatively low bulk density which can lead to enhanced processability and improved dispersion. For instance, the smaller particles can exhibit better flow properties that can be more easily processed using techniques, such as extrusion or injection molding. This can result in improved manufacturability and lower production costs. In addition, the finer particles of the present disclosure have a particle morphology that causes the particles to disperse more evenly, uniformly, and faster in matrices such as other polymers, plasticizers, or solvents. This can result in more uniform properties throughout the resulting article and better performance especially in applications where the polymers are used to produce components in an energy storage device, such as a battery.

The extremely fine particles of the present disclosure can also lead to enhanced mechanical properties, such as tensile strength, impact resistance, stiffness and wear properties. This is particularly useful in applications where strength and durability are important, such as when producing porous membranes or separators for energy storage devices.

The polymer micropowder of the present disclosure also contains very fine particles that have a higher surface area-to-volume ratio, which can be advantageous in many applications. The increased surface area can improve adhesion, bonding, and interaction with other materials.

In addition, by reducing and controlling the particle size distribution of the particles contained in the polymer micropowder, it is possible to tailor the properties of the high density particles to specific applications. In this manner, improvements can be achieved in producing desired rheological behavior, surface roughness, and/or barrier properties. Overall, the high density polymer micropowder of the present disclosure offers a range of benefits that can lead to improved performance and versatility in many different applications.

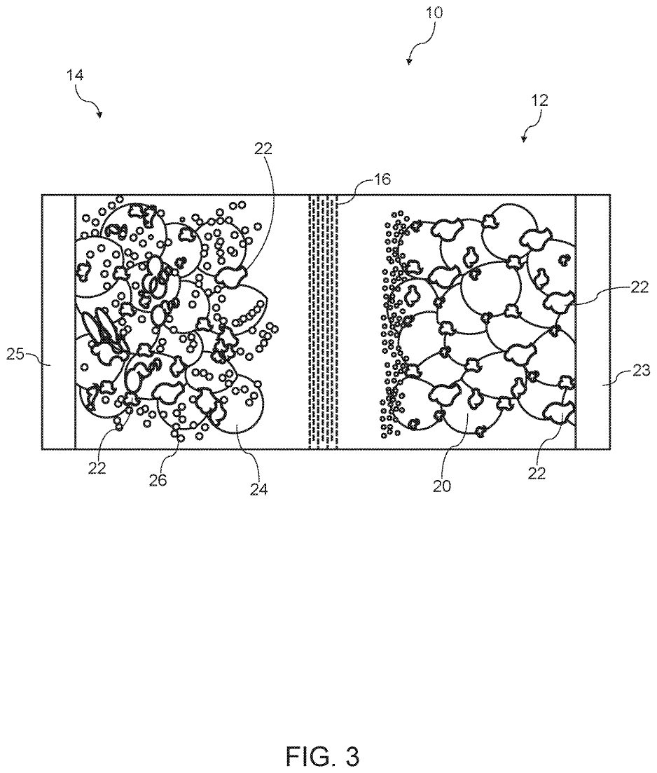

As described above, in one aspect, the polymer micropowder of the present disclosure can be formed by grinding larger high density polyethylene multi-nodal polymer particles. More particularly, in one aspect, the present disclosure is directed to producing super-nodal high density polyethylene particles that are easier to grind and can produce a micropowder much more efficiently. For example, FIG. 2 represents one embodiment of a multi-nodal high density polyethylene particle made in accordance with the present disclosure. As shown, the particle is comprised of extremely small nodes in an interconnecting network. Not only does the particle in FIG. 2 show extremely small nodes on the surface of the particle but also displays a very high density of the nodes. As shown in FIG. 2, for instance, the entire particle appears to be made from small nodes covering the surface of the particle.

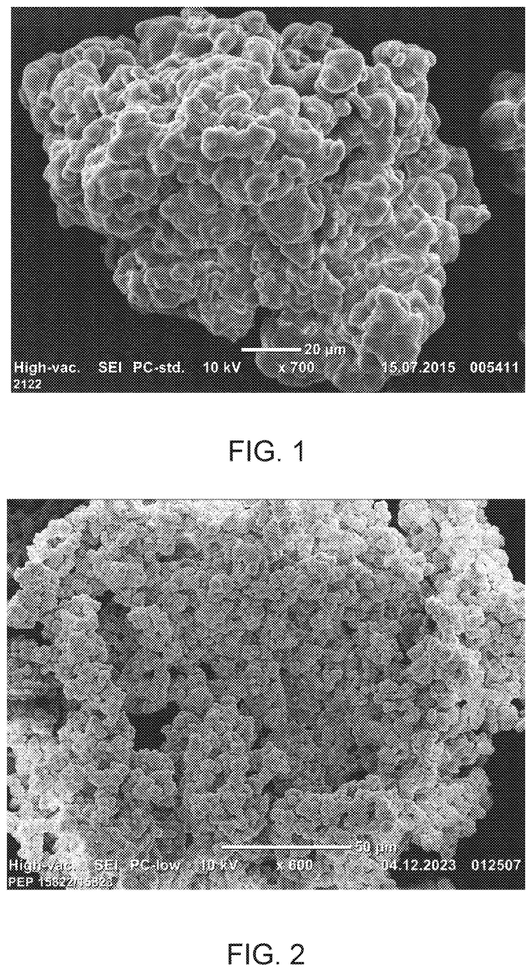

For purposes of comparison, FIG. 1 illustrates a conventionally made high density polyethylene particle which is typically referred to as a “popcorn” particle. As shown comparing FIGS. 1 and 2, the particle of FIG. 2 not only is made from much smaller nodes but the nodes are also more uniform and are in much greater quantities than the popcorn-like particles shown in FIG. 1.

The nodes on the surface of high density polyethylene particles made in accordance with the present disclosure, for instance, can display an average nodule size of less than about 5.5 microns, such as less than about 5 microns, such as less than about 4.5 microns, such as less than about 4 microns, such as less than about 3.5 microns. The nodes can have an average nodule size of greater than about 0.5 microns, such as greater than about 1 micron, such as greater than about 1.5 microns, such as greater than about 2 microns, such as greater than about 2.5 microns.

The particle size distribution of the nodes on the surface of the high density polyethylene particles made according to the present disclosure can be such that none of the nodes have a nodule size of greater than about 12 microns, such as greater than about 10 microns, such as greater than about 9 microns, such as greater than about 8 microns. In addition, in one aspect, none of the nodes on the surface of the high density polyethylene particles can have a size of less than about 0.3 microns, such as less than about 0.1 micron, such as less than about 0.01 micron. In this manner, a particle size distribution can be obtained that, when the particles are ground, produces a micropowder having particles with a relatively uniform particle size and without producing any significant amounts of dust or fines in the resulting product.

The initial size of the high density multi-nodal polyethylene particles as shown in FIG. 2 can vary depending upon the particular application. For instance, the particles can have a median particle size (D50) of less than about 500 microns, such as less than about 400 microns, such as less than about 300 microns, such as less than about 200 microns, such as less than about 150 microns, such as less than about 120 microns, such as less than about 100 microns, such as less than about 70 microns. The median particle size of the high density polyethylene polymer particles is generally greater than 20 microns, such as greater than about 30 microns, such as greater than about 40 microns, such as greater than about 50 microns, such as greater than about 60 microns, such as greater than about 70 microns.

In accordance with the present disclosure, the multi-nodal particles as shown in FIG. 2 can be fed through a grinding process which, as used herein, also includes milling processes. During the grinding process, the high density polyethylene polymer particles are ground down to a desired particle size. During grinding, the particles are broken down into very fine particles. During the process, at least certain of the nodes are broken off from the rest of the particle for forming very small particles having the desired characteristics of the present disclosure.

In general, any suitable grinding process can be used that is capable of breaking down the high density polyethylene polymer particles as shown in FIG. 2. In one aspect, for instance, jet milling may be used to reduce the particle size. During jet milling, the high density polyethylene polymer particles as shown in FIG. 2 can optionally be dried and/or sieved to ensure uniformity in size and moisture content. In one aspect, the large high density polyethylene particles are fed into a milling chamber. The milling chamber can be a cylindrical chamber with nozzles or jets positioned on the periphery of the chamber. During grinding, high pressure gas or air is used to create high speed fluid jets within the milling chamber. These jets are directed towards the particles. As the high-speed fluid jets collide with the high density polyethylene particles, they impact kinetic energy to the particles. This energy causes the particles to collide with each other and with the walls of the milling chamber. These collisions lead to fracturing of the particles into much smaller sizes.

Optionally, after milling, the resulting ground particles can be classified based on their size using an air classifier. For instance, if necessary or desired, the smaller particles can be separated from the coarser particles. The finer particles can be collected, while the coarser particles may undergo further milling steps. The fine high density polyethylene particles can be collected using any suitable process or technique. For instance, a cyclone separator or a bag filter may be used to collect the resulting particles.

Jet milling may offer some advantages over other grinding processes. For instance, jet milling allows for precise control over the particle size distribution. Jet milling can also be efficient in reducing particle size in which very fine particle sizes can be obtained in a relatively short amount of time. Jet milling can also be scaled up to accommodate large production volumes.

As described above, the multi-nodal high density polyethylene particles of the present disclosure are relatively easy to grind for efficiently producing a micropowder. In this regard, the particles can be ground without being subjected to any pre-treatments or post-treatments, such as a crosslinking process. In addition, the use of a grinding aid is not necessary in order to produce the micropowder. In one aspect, however, a grinding aid can be present. The grinding aid can comprise particles that have a hardness greater than the polyethylene polymer particles that collide with the particles during milling for generating smaller particles and/or increasing the grinding speed or rate. The grinding aid can also comprise a grinding lubricant.

Grinding aids are additives that are combined with the high density polyethylene polymer particles that are used to enhance the efficiency of the grinding process, typically by reducing the energy consumption required for size reduction and improving the flowability of the material being ground.

For instance, during jet milling, grinding aids can assist in the fragmentation of the high density polyethylene particles. The grinding aids can also help prevent the agglomeration of the high density polyethylene polymer particles during jet milling. This can lead to a more uniform particle size distribution and improve flow properties. Examples of grinding aids that may be used in accordance with the present disclosure include zircon particles, zirconium particles, quartz particles, or mixtures thereof. In one embodiment, the grinding aid can be water soluble. For example, one example of a water soluble grinding aid comprises sodium chloride particles. The grinding aids can have a (D50) particle size of from about 0.001 microns to about 100 microns. For example, the grinding aids can have a (D50) particle size of less than about 75 microns, such as less than about 50 microns, such as less than about 25 microns, such as less than about 10 microns, and greater than about 1 micron.

In another embodiment, the grinding aid can be a lubricant that also prevents agglomerations and improve milling efficiency by creating a greater amount of collisions during the process.

Grinding aids can be added during jet milling in an amount greater than about 3% by weight, such as in an amount greater than about 5% by weight, such as in an amount greater than about 10% by weight, such as in an amount greater than about 15% by weight, such as in an amount greater than about 20% by weight, such as in an amount greater than about 25% by weight, such as in an amount greater than about 30% by weight, such as in an amount greater than about 40% by weight, such as in an amount greater than about 50% by weight, and in an amount less than about 70% by weight, such as in an amount less than about 55% by weight, such as in an amount less than about 50% by weight, such as in an amount less than about 45% by weight, such as in an amount less than about 30% by weight.

When one or more grinding aids are used, the grinding aids can be easily separated from the ground high density polyethylene particles. For instance, high density polyethylene particles typically have a density less than water and can be separated from many grinding aids using a flotation technique. Alternatively, as described above, a grinding aid can be used that is water soluble. In this embodiment, the ground high density polyethylene particles can be rinsed with water or placed in a water bath for dissolving and removing the grinding aid.

Through the process of the present disclosure, very small high density polyethylene particles can be produced. The median particle size (D50) of the particles can be less than about 15 microns, such as less than about 12 microns, such as less than about 10 microns, such as less than about 9.5 microns, such as less than about 9 microns, such as less than about 8.75 microns, and generally greater than about 2 microns, such as greater than about 4 microns, such as greater than about 5 microns.

The polymer micropowder of the present disclosure can also have a relatively narrow particle size distribution. For instance, the polymer particles can display a 10th percentile particle size of greater than about 0.5 microns, such as greater than about 1 micron, such as greater than about 1.5 microns, such as greater than about 2 microns, and less than about 3 microns, such as less than about 2.5 microns, such as less than about 2 microns. The polymer micropowder can display a 90^{th} percentile particle size of greater than about 12 microns, such as greater than about 14 microns, and less than about 25 microns, such as less than about 22 microns, such as less than about 19 microns, such as less than about 17 microns.

The resulting ground high density polyethylene particles can have irregular particle shapes. For instance, the particles can be non-spherical having a rough outer surface. Of particular advantage, the very small high density polyethylene polymer particles can optionally have a relatively low bulk density. For instance, the bulk density can be less than about 0.38 g/cc, such as less than about 0.36 g/cc, such as less than about 0.34 g/cc, such as less than about 0.32 g/cc, such as less than about 0.3 g/cc, such as less than about 0.28 g/cc. The bulk density is generally greater than about 0.15 g/cc, such as greater than about 0.2 g/cc. The low bulk density is believed to provide numerous advantages and benefits. For instance, the low bulk density produces polymer particles that can easily be dispersed in other liquid and polymer systems, which can improve processing and handling. In this manner, molded articles can be produced having more uniform properties.

The high density polyethylene polymer contained in the ground high density polyethylene polymer particles can optionally display a relatively high or low Shore D hardness and melting temperature. For instance, the Shore D hardness of the polymer contained in the particles can be less than about 63, such as less than about 61, such as less than about 60, and greater than about 50, such as greater than about 55, such as greater than about 58. Alternatively, the Shore D hardness of the polymer contained in the particles can be greater than about 63, such as greater than about 65, such as greater than about 68, and less than about 90. The melting temperature of the polymer contained within the particles can be less than about 135.5 °C, such as less than about 135.1 °C, and greater than about 130 °C, such as greater than about 133 °C, such as greater than about 134 °C. Alternatively, the melting temperature of the polymer contained within the particles can be greater than about 136 °C, such as greater than about 137 °C, and less than about 140 °C.

As described above, the polymer micropowder of the present disclosure has many uses and applications. The polymer micropowder, for instance, can be used as an additive in a liquid or gel system. Alternatively, the polymer micropowder can be molded to form various articles, including sintered products. In still another aspect, the polymer micropowder can be used as a binder in ceramic or polymer systems. In still another embodiment, the polymer micropowder of the present disclosure can be used as an additive and compounded with various thermoplastic polymers. The polymer micropowder of the present disclosure can serve as an anti-wear agent and may also possess tribological properties. In still another embodiment, the polymer micropowder of the present disclosure can be incorporated into a lubricant composition, such as an oil-based or grease-based composition.

In one particular embodiment, the polymer micropowder of the present disclosure can be used to produce one or more components in an energy storage device, such as an ion battery. The ion battery can be, for instance, a lithium ion battery or a sodium ion battery. Referring to FIG. 3, for instance, a simplified figure of an energy storage device or battery 10 is illustrated. The battery 10 includes an anode 12 separated from a cathode 14 by a porous separator 16. The anode 12 is one of the electrodes in the battery 10 and can be made of a carbon material, such as graphite. During discharge, lithium ions move from the anode 12 to the cathode 14 through the separator 16.

The cathode 14 is the other electrode contained in the battery 10 and can comprise a lithium-containing metal oxide. The cathode 14 serves as a positive electrode during discharge.

The separator 16 is a thin, porous material placed between the anode 12 and the cathode 14 to physically separate the electrodes while allowing the flow of ions. The separator 16 prevents short circuits by preventing direct contact between the two electrodes. In one embodiment, the separator 16 can comprise a porous membrane made from the high density polyethylene polymer particles of the present disclosure. The high density polyethylene polymer, for instance, can be gel extruded into a porous membrane and incorporated into the battery 10. The high density polyethylene polymer particles can also be incorporated into the electrodes 12 and 14.

The anode 12, for instance, includes a network of an active material 20 held together by a binder 22 in accordance with the present disclosure. The active material, for instance, can comprise a carbon material while the binder 22 comprises the high density polyethylene polymer particles. The active material 20 and the binder 22 have been dry mixed together and formed into an electrode film under heat and pressure to form the anode 12. The anode 12 can further include a current collector 23. The electrode film made from the active material 20 and the binder 22 is laminated to the current collector 23. The current collector 23 facilitates flow of electrical current to and from the active material 20. For instance, the electrode film made from the active material 20 and the binder 22 is porous in nature. The current collector 23 serves as the substrate that can efficiently conduct electricity. When a voltage is applied to the electrode, electrons flow through the current collector, allowing the electrode to deliver or accept electrical charge. In one embodiment, the current collector 23 for the anode 12 can comprise a metal foil, such as a copper foil.

The cathode 14 also includes an active material 24 held together by the binder 22. The active material 24 in a cathode 14 may comprise, for instance, a lithium-containing material, such as a lithium-containing metal oxide or a sodium-containing material. As shown, the cathode 14 can also include an additive 26. The additive 26, for instance, may comprise a conductive additive to improve the electrical conductivity of the cathode 14. The additive 26 can also comprise a salt, a dopant, or an electrolyte additive.

The cathode 14 also includes a current collector 25 comprising a metal foil. For instance, the current collector 25 may comprise an aluminum foil.

The battery 10 as shown in FIG. 3 can also include an electrolyte. The electrolyte is a chemical compound that allows for the flow of lithium ions between the anode 12 and the cathode 14 while preventing direct electrical contact between the electrodes. The electrolyte, for instance, can comprise a lithium or sodium salt dissolved in a solvent, such as a lithium hexafluorophosphate dissolved in a solvent like ethylene carbonate and/or dimethyl carbonate.

The battery 10, as shown in FIG. 3, can further include an enclosure or housing for protecting the components including the electrodes. The housing can be made from a metal or a plastic. Further, the battery 10 can include terminals on the outside of the casing or housing which are used to connect the battery to external devices or charging equipment. The battery 10 can also include a vent to prevent overcharging, over-discharging, and overheating. The vent, for instance, can comprise a passageway that allows gas to escape in the event of over pressure or thermal runaway.

Whether constructing the anode 12 or the cathode 14, a binder is used in order to hold together the active material for forming an electrode film that can then be laminated to the current collector. In accordance with the present disclosure, the binder 22 comprises high density polyethylene polymer particles in the form of a polymer micropowder.

The high density polyethylene polymer used to form the polymer micropowder of the present disclosure can generally have a density of about 0.92 g/cm³ or greater, such as about 0.93 g/cm³ or greater, such as about 0.94 g/cm³ or greater, and generally less than about 1 g/cm³, such as less than about 0.97 g/cm³.

The high density polyethylene polymer can be made from over 90% ethylene derived units, such as greater than 95% ethylene derived units, or from 100% ethylene derived units. The polyethylene can be a homopolymer or a copolymer, including a terpolymer, having other monomeric units.

The high density polyethylene can be a high molecular weight polyethylene, a very high molecular weight polyethylene, and/or an ultrahigh molecular weight polyethylene. “High molecular weight polyethylene” refers to polyethylene compositions with an average molecular weight of at least about 2×10⁵ g/mol and, as used herein, is intended to include very-high molecular weight polyethylene and ultra-high molecular weight polyethylene. For purposes of the present specification, the molecular weights referenced herein are determined in accordance with the Margolies equation (“Margolies molecular weight”).

“Very-high molecular weight polyethylene” refers to polyethylene compositions with a weight average molecular weight of less than about 3×10⁶ g/mol and more than about 1×10⁶ g/mol. In some embodiments, the molecular weight of the very-high molecular weight polyethylene composition is between about 2×10⁶ g/mol and less than about 3×10⁶ g/mol.

“Ultra-high molecular weight polyethylene” refers to polyethylene compositions with an average molecular weight of at least about 3×10⁶ g/mol. In some embodiments, the molecular weight of the ultra-high molecular weight polyethylene composition is between about 3×10⁶ g/mol and about 30×10⁶ g/mol, or between about 3×10⁶ g/mol and about 20×10⁶ g/mol, or between about 3×10⁶ g/mol and about 10×10⁶ g/mol, or between about 3×10⁶ g/mol and about 6×10⁶ g/mol.

In one aspect, the high density polyethylene is a homopolymer of ethylene. In another embodiment, the high density polyethylene may be a copolymer. For instance, the high density polyethylene may be a copolymer of ethylene and another olefin containing from 3 to 16 carbon atoms, such as from 3 to 10 carbon atoms, such as from 3 to 8 carbon atoms. These other olefins include, but are not limited to, propylene, 1-butene, 1-pentene, 1-hexene, 1-heptene, 1-octene, 4-methylpent-1-ene, 1-decene, 1-dodecene, 1-hexadecene and the like. Also utilizable herein are polyene comonomers such as 1,3-hexadiene, 1,4-hexadiene, cyclopentadiene, dicyclopentadiene, 4-vinylcyclohex-1-ene, 1,5-cyclooctadiene, 5-vinylidene-2-norbornene and 5-vinyl-2-norbornene. However, when present, the amount of the non-ethylene monomer(s) in the copolymer may be less than about 10 mol. %, such as less than about 5 mol. %, such as less than about 2.5 mol. %, such as less than about 1 mol. %, wherein the mol. % is based on the total moles of monomer in the polymer.

In one embodiment, the high density polyethylene may have a monomodal molecular weight distribution. Alternatively, the high density polyethylene may exhibit a bimodal molecular weight distribution. For instance, a bimodal distribution generally refers to a polymer having a distinct higher molecular weight and a distinct lower molecular weight (e.g. two distinct peaks) on a size exclusion chromatography or gel permeation chromatography curve. In another embodiment, the high density polyethylene may exhibit more than two molecular weight distribution peaks such that the polyethylene exhibits a multimodal (e.g., trimodal, tetramodal, etc.) distribution. Alternatively, the high density polyethylene may exhibit a broad molecular weight distribution wherein the polyethylene is comprised of a blend of higher and lower molecular weight components such that the size exclusion chromatography or gel permeation chromatography curve does not exhibit at least two distinct peaks but instead exhibits one distinct peak broader than the individual component peaks.

The molecular weight of the high density polyethylene polymer, for instance, can generally be greater than about 200,000 g/mol, such as greater than about 300,000 g/mol, such as greater than about 400,000 g/mol, such as greater than about 500,000 g/mol, such as greater than about 650,000 g/mol, such as greater than about 800,000 g/mol, such as greater than about 1,250,000 g/mol, such as greater than about 1,500,000 g/mol, such as greater than about 1,750,000 g/mol, such as greater than about 2,000,000 g/mol, such as greater than about 2,250,000 g/mol, such as greater than about 2,500,000 g/mol, such as greater than about 2,750,000 g/mol, such as greater than about 3,000,000 g/mol, such as greater than about 3,250,000 g/mol, such as greater than about 3,500,000 g/mol. The molecular weight of the one or more polyethylene polymers is generally less than about 13,000,000 g/mol, such as less than about 11,000,000 g/mol, such as less than about 10,000,000 g/mol, such as less than about 8,000,000 g/mol, such as less than about 6,000,000 g/mol, such as less than about 4,500,000 g/mol, such as less than about 3,500,000 g/mol, such as less than about 3,000,000 g/mol, such as less than about 2,500,000 g/mol.

The multi-nodal polyethylene particles are produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum or magnesium compound as cocatalyst. The ethylene is usually polymerized in gaseous phase or slurry phase at relatively low temperatures and pressures. The polymerization reaction may be carried out at a temperature of between 50 °C and 100 °C and pressures in the range of 0.02 and 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid wall fouling and product contamination.

Suitable catalyst systems include but are not limited to Ziegler-Natta type catalysts. Typically Ziegler-Natta type catalysts are derived by a combination of transition metal compounds of Groups 4 to 8 of the Periodic Table and alkyl or hydride derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum or magnesium compounds, such as for example but not limited to aluminum or magnesium alkyls and titanium, vanadium or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system could be obtained by the reaction of a titanium (IV) compound with a trialkyl aluminum compound in an inert organic solvent at temperatures in the range of −40 °C to 100 °C, preferably −20 °C to 50 °C. The concentrations of the starting materials are in the range of 0.1 to 9 mol/L, preferably 0.2 to 5 mol/L, for the titanium (IV) compound and in the range of 0.5 to 5 mol/L for the trialkyl aluminum compound. The titanium component is added to the aluminum component over a period of 0.1 min to 60 mins, preferably 1 min to 30 mins.

In another embodiment, a suitable catalyst system is obtained by a one or two-step reaction of a titanium (IV) compound with a trialkyl aluminum compound in an inert organic solvent at temperatures in the range of −40 °C to 200 °C, preferably −20 °C to 150 °C. In the first step, the titanium (IV) compound is reacted with the trialkyl aluminum compound at temperatures in the range of −40 °C to 100 °C, preferably −20 °C to 50 °C. The concentrations of the starting materials are in the range of 0.1 to 9.1 mol/L, preferably 5 to 9.1 mol/L, for the titanium (IV) compound and in the range of 0.1 and 2 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10 °C to 150 °C, preferably 10 °C to 130 °C.

In a further embodiment, catalysts supported on silica, such as for example the commercially available catalyst system Sylopol 5917 can also be used.

Using such catalyst systems, the polymerization is normally carried out in suspension at low pressure and temperature in one or multiple steps, continuous or batch. The polymerization temperature is typically in the range of 30 °C to 150 °C, preferably in the range of 50 °C and 110 °C and the ethylene partial pressure is typically less than 10 MPa, preferably 0.05 and 5 MPa. Trialkyl aluminums, like for example but not limited to isoprenyl aluminum and triisobutyl aluminum, are used as co-catalyst. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed dryer under nitrogen. The solvent may be removed through steam distillation in case of using high boiling solvents. Salts of long chain fatty acids may be added as a stabilizer. Typical examples are calcium-magnesium and zinc stearate.

In order to produce the multi-nodal particles as shown in FIG. 2, various different processing techniques can be used. For instance, the aluminum to titanium ratio can be increased in the catalyst system within the ranges described above. In addition, the reactants can be added in a rapid fashion to the polymerization reactor. By using one or both of these steps, the reaction kinetics increase causing particles to be formed having the multi-nodal configuration. In the past, polymerization processes were typically carried out in order to produce a more spherical particle. According to the present disclosure, however, reactant dilution controls can be removed, while increasing the aluminum to titanium ratio for producing the multi-nodal particles as illustrated in FIG. 2.

One particular advantage to producing high density polyethylene particles in accordance with the present disclosure is that the resulting particles contain extremely low levels of catalyst residue. For instance, the particles can contain catalyst residue in an amount less than about 100 ppm, such as in an amount less than about 60 ppm, such as in an amount less than about 50 ppm, such as in an amount less than about 40 ppm, such as in an amount less than about 30 ppm, such as in an amount less than about 20 ppm. Catalyst residue can be measured by the amount of titanium, magnesium, aluminum, and chlorine.

After the high density polyethylene polymer particles are formed, the particles are ground to form the polymer micropowder of the present disclosure. The polymer micropowder, as described above, can then be used to produce various components of the battery 10 as shown in FIG. 3. The polymer micropowder, for instance, can be used as a binder in one of the electrodes and/or can be used to produce the separator 16.

When used as a binder to produce an electrode film, the binder can be incorporated into the electrode film in an amount from about 0.01% by weight to about 15% by weight including all increments of 0.1% by weight therebetween. For instance, the binder particles can be incorporated into the electrode film in an amount greater than about 0.3% by weight, such as in an amount greater than about 0.5% by weight, such as in an amount greater than about 0.8% by weight, such as in an amount greater than about 1% by weight, such as in an amount greater than about 1.2% by weight, such as in an amount greater than about 1.5% by weight, such as in an amount greater than about 1.7% by weight, such as in an amount greater than about 2% by weight, such as in an amount greater than about 2.2% by weight. The binder particles are generally incorporated into the electrode film in an amount less than about 10% by weight, such as in an amount less than about 8% by weight, such as in an amount less than about 6% by weight, such as in an amount less than about 4% by weight, such as in an amount less than about 3.5% by weight, such as in an amount less than about 3% by weight.

The binder can be made exclusively or only from the high density polyethylene particles. Alternatively, the binder can comprise the high density polyethylene particles combined with fluoropolymer particles, such as polytetrafluoroethylene particles. The fluoropolymer particles, such as PTFE particles, can be present in the binder in an amount of from about 0.1% by weight to about 99.9% by weight, such as from about 2% by weight to about 40% by weight, such as from about 5% by weight to about 25% by weight.

The particles are combined with an active material and possibly other auxiliary agents and formed into an electrode film. In one aspect, the film can be a solventless film meaning that the film is formed without using a solvent. A solventless film, for instance, contains no processing solvents or processing solvent residues. The film, however, may contain atmospheric moisture.

In order to form the electrode film, in one embodiment, the binder particles can be combined with active material particles and first dry mixed together. After dry mixing, the particles can be subjected to heat and pressure sufficient to form a film. Heat and pressure is applied to the mixture in order for the binder particles or high density polyethylene polymer particles to flow and form an interconnected network of the active material. The resulting electrode film can be freestanding and is then laminated to a current collector, such as a metal foil.

As described above, the binder particles of the present disclosure can be used to produce anodes or cathodes. Consequently, the active material that is combined with the binder can vary depending upon the particular application. Anode active materials can comprise, for example, an insertion material (such as carbon, graphite, and/or graphene), an alloying/dealloying material (such as silicon, silicon oxide, tin, and/or tin oxide), a metal alloy or compound (such as Si—Al, and/or Si—Sn), and/or a conversion material (such as manganese oxide, molybdenum oxide, nickel oxide, and/or copper oxide). The anode active materials can be used alone or mixed together to form multi-phase materials (such as Si—C, Sn—C, SiOx—C, SnOx—C, Si—Sn, Si—SiOx, Sn—SnOx, Si—SiOx—C, Sn—SnOx—C, Si—Sn—C, SiOx—SnOx—C, Si—SiOx—Sn, or Sn—SiOx—SnOx).

The active material particles can be present in the electrode film in an amount from about 40% by weight to about 99.5% by weight, including all increments of 0.5% by weight therebetween. For instance, the active material contained in the electrode film to produce an anode, which can be graphite in one embodiment, can be present in the electrode film in an amount greater than about 60% by weight, such as in an amount greater than about 70% by weight, such as in an amount greater than about 80% by weight, such as in an amount greater than about 90% by weight, such as in an amount greater than about 93% by weight, such as in an amount greater than about 95% by weight.

In addition to the active material and binder, the anode film made in accordance with the present disclosure can also contain a conductive additive. The conductive additive may comprise from about 0.01% by weight to about 5% by weight of the electrode film. For instance, the conductive additive can be present in the electrode film in an amount greater than about 0.3% by weight, such as in an amount greater than about 0.8% by weight, such as in an amount greater than about 1% by weight, such as in an amount greater than about 1.2% by weight, and in an amount less than about 5% by weight, such as in an amount less than about 3% by weight. The electrode film used to form an anode may also contain various other additives.

When producing electrode films for constructing cathodes, the cathode active material can include a sodium salt lithium metal oxide and/or a lithium sulfide. In some embodiments, the cathode active material may include lithium nickel manganese cobalt oxide (NMC), lithium manganese oxide (LMO), lithium iron phosphate (LFP), lithium cobalt oxide (LCO), lithium nickel manganese oxide and/or lithium nickel cobalt aluminum oxide (NCA). The cathode active material can comprise sulfur or a material including sulfur, such as lithium sulfide (Li2S), or other sulfur-based materials, or a mixture thereof. In some embodiments, the cathode film comprises a sulfur or a material including sulfur active material at a concentration of at least 50 wt %. In some embodiments, the cathode film comprising a sulfur or a material including sulfur active material has an areal capacity of at least 10 mAh/cm². In some embodiments, the cathode film comprising a sulfur or a material including sulfur active material has an electrode film density of 1 g/cm³. In some embodiments, the cathode film comprising a sulfur or a material including sulfur active material further comprises a binder.

One or more active materials can be contained in a cathode film in an amount from about 50% by weight to about 99.5% by weight, including all increments of 0.1% by weight therebetween. For instance, one or more active materials can be contained in the cathode film in an amount greater than about 60% by weight, such as in an amount greater than about 70% by weight, such as in an amount greater than about 80% by weight, such as in an amount greater than about 90% by weight, such as in an amount greater than about 93% by weight, such as in an amount greater than about 95% by weight.

Similar to the anode, the cathode film can also contain a conductive additive comprising any of the carbon materials described above in the amounts described above. The cathode film may also contain a dopant, such as aluminum, nickel, or titanium, a lithium salt, or an electrolyte additive.

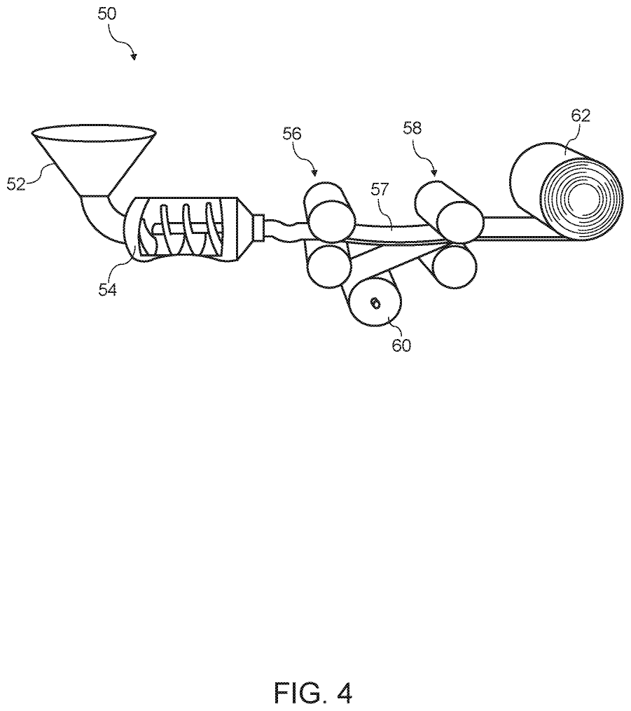

One embodiment of a process 50 for producing electrode films in accordance with the present disclosure is illustrated in FIG. 4. As shown, the high molecular weight polyethylene polymer binder particles are combined with active material particles and optionally with other additives and fed to a hopper 52. From the hopper 52, the dry mixture is blended optionally in a mixer. When mixing the components together, no liquid solvents are used. The mixer can be any suitable mixer, such as a tumbler mixer, a motorized blender, or can be combined through shaking. In one embodiment, the binder and active material can be fed through a dry milling step together in order to create a homogeneous mixture and control particle size.

After being mixed, the dry mixture is subjected to heat and pressure that causes a porous film to be produced. In particular, heat and pressure are applied causing the binder particles to flow and attach together the active material particles. In this manner, a porous matrix of the active material is formed.

As shown in FIG. 4, in one embodiment, the dry mixture can be first fed through an extruder 54. The extruder 54 can heat the dry mixture to a temperature of greater than about 80 °C, such as greater than about 100 °C, such as greater than about 110 °C, and to a temperature of less than about 200 °C, such as less than about 150 °C. The screw in the extruder can operate at a speed from about 20 RPM to about 100 RPM, such as from about 30 RPM to about 60 RPM and at a torque of greater than about 3 Nm and less than about 15 Nm, such as from about 7 Nm to about 8 Nm.

A film can exit the extruder 54 and fed to a calendering device 56 that comprises a pair of opposing compression rolls. One or more of the rolls can be heated. The calendering device 56 forms a nip and the dry mix of materials can be subjected to a temperature of from about 70 °C to about 250 °C. For instance, the temperature within the nip can be greater than about 100 °C, such as greater than about 125 °C, such as greater than about 150 °C, such as greater than about 175 °C, such as greater than about 185 °C, such as greater than about 200 °C, such as greater than about 205 °C, such as greater than about 210 °C, and less than about 240 °C, such as less than about 220 °C. The pressure applied within the nip can be greater than about 0.1 MPa, such as greater than about 0.5 MPa, such as greater than about 1 MPa, such as greater than about 2 MPa, such as greater than about 3 MPa, such as greater than about 4 MPa, such as greater than about 5 MPa, and less than about 10 MPa, such as less than about 9 MPa, such as less than about 8 MPa, such as less than about 7 MPa, such as less than about 6 MPa.

In one aspect, the calendaring device 56 can include a gap nip where the opposing rolls form a gap through which the molten polymer film is fed. The gap, for instance, can have a height of greater than about 50 μm, such as greater than about 100 μm, such as greater than about 200 μm, as greater than about 300 μm, and less than about 1000 μm, such as less than about 900 μm, such as less than about 800 μm, such as less than about 700 μm, such as less than about 500 μm.

In one embodiment, the formed sheet or film is subjected to active cooling. For instance, the electrode film 57, as shown in FIG. 4, can be cooled to less than about 100 °C, such as less than about 80 °C, in less than about 10 mins., such as less than about 8 mins., such as less than about 5 mins.

Once the electrode film 57 is formed, the film is then fed to a laminating device 58 and laminated to a current collector 60, such as a metal foil. The laminating device may apply heat and pressure sufficient to cause the electrode film 57 to adhere to the current collector 60. In one embodiment, an adhesive or tie layer may be present on the current collector 60 for facilitating the formation of a bond between the two materials.

Once the electrode film 57 is laminated to the current collector 60, the resulting laminate can be wound into a roll 62. Later, the laminate can be unwound, cut into strips, and fed into a process for producing energy storage devices, such as lithium ion batteries.

The basis weight of the electrode film 57 on the current collector 60 can vary depending upon the particular application. The basis weight of electrode film is generally greater than about 10 gsm, such as greater than about 20 gsm, such as greater than about 30 gsm, such as greater than about 40 gsm, such as greater than about 50 gsm, such as greater than about 60 gsm, such as greater than about 70 gsm, such as greater than about 80 gsm, such as greater than about 90 gsm, such as greater than about 100 gsm, such as greater than about 110 gsm, such as greater than about 120 gsm, such as greater than about 130 gsm, such as greater than about 140 gsm, such as greater than about 150 gsm, such as greater than about 160 gsm, such as greater than about 170 gsm, such as greater than about 180 gsm, such as greater than about 190 gsm, such as greater than about 200 gsm. The basis weight is generally less than about 500 gsm, such as less than about 450 gsm, such as less than about 400 gsm, such as less than about 350 gsm, such as less than about 300 gsm, such as less than about 275 gsm, such as less than about 250 gsm, such as less than about 225 gsm, such as less than about 200 gsm, such as less than about 175 gsm, such as less than about 150 gsm, such as less than about 125 gsm.

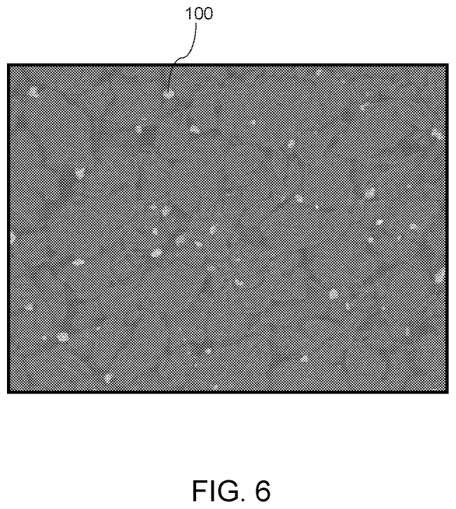

Referring to FIG. 6, one embodiment of an electrode film made in accordance with the present disclosure is shown. As described above, the ground high density polyethylene particles are used as a binder within the film. Of particular advantage, the high density polyethylene remains as particles 100 in the resulting film as shown in FIG. 6. The high density polyethylene particles, for instance, can reduce in size during mixing and/or extrusion. At least some of the resulting high density polyethylene particles 100 present in the film, for instance, can have a size of greater than about 0.5 μm, such as greater than about 1 μm, and less than about 10 μm, such as less than about 8 μm, such as less than about 5 μm, such as less than about 4 μm, such as less than about 3 μm when measured using an SEM microscope.

As shown in FIG. 6, in one embodiment, when an electrode film is viewed under an SEM microscope, the amount of high density polyethylene particles visible on the surface of the film can be in an amount of from about 10 particles per 100 μm² to about 500 particles per 100 μm². For instance, the film can have greater than about 20 particles per 100 μm², such as greater than about 30 particles per 100 μm², such as greater than about 40 particles per 100 μm² and less than about 300 particles per 100 μm², such as less than about 200 particles per 100 μm², such as less than about 100 particles per 100 μm², such as less than about 80 particles per 100 μm².

When incorporated into an energy storage device, such as a lithium ion battery, as described above, the anode and cathode are separated by a porous membrane or separator. In one aspect, the separator can comprise a porous membrane also made from the very high or an ultrahigh molecular weight polyethylene polymer particles of the present disclosure.

In forming porous polymer films in accordance with the present disclosure, the high density polyethylene particles can be combined with a plasticizer and then gel extruded.

When combined with a plasticizer in forming porous films or membranes, the high density polyethylene particles are present in the polymer composition in an amount up to about 50% by weight. For instance, the high density polyethylene particles can be present in the polymer composition in an amount less than about 45% by weight, such as in an amount less than about 40% by weight, such as in an amount less than about 35% by weight, such as in an amount less than about 30% by weight, such as in an amount less than about 25% by weight, such as in an amount less than about 20% by weight, such as in an amount less than about 15% by weight. The polyethylene particles can be present in the composition in an amount greater than about 5% by weight, such as in an amount greater than about 10% by weight, such as in an amount greater than about 15% by weight, such as in an amount greater than about 20% by weight, such as in an amount greater than about 25% by weight.

During gel processing, a plasticizer is combined with the high density polyethylene particles which can be substantially or completely removed in forming polymer articles. For example, in one embodiment, the resulting polymer article can contain the high density polyethylene polymer in an amount greater than about 50% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight, such as in an amount greater than about 99% by weight, such as in an amount greater than about 99.5% by weight.

The plasticizer, for instance, may comprise a hydrocarbon oil, an alcohol, an ether, an ester such as a diester, or mixtures thereof. For instance, suitable plasticizers include mineral oil, a paraffinic oil, decaline, and the like. Other plasticizers include xylene, dioctyl phthalate, dibutyl phthalate, stearyl alcohol, oleyl alcohol, decyl alcohol, nonyl alcohol, diphenyl ether, n-decane, n-dodecane, octane, nonane, kerosene, toluene, naphthalene, tetraline, and the like. In one embodiment, the plasticizer may comprise a halogenated hydrocarbon, such as monochlorobenzene. Cycloalkanes and cycloalkenes may also be used, such as camphene, methane, dipentene, methylcyclopentandiene, tricyclodecane, 1,2,4,5-tetramethyl-1,4-cyclohexadiene, and the like. The plasticizer may comprise mixtures and combinations of any of the above as well.

The plasticizer is generally present in the composition used to form the polymer articles in an amount greater than about 50% by weight, such as in an amount greater than about 55% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight. In fact, the plasticizer can be present in an amount up to about 99.5% by weight.

The high density polyethylene particles blend with the plasticizer to form a homogeneous gel-like material.

In order to form polymer articles in accordance with the present disclosure, the high density polyethylene particles are combined with the plasticizer and extruded through a die of a desired shape. In one embodiment, the composition can be heated within the extruder. For example, the plasticizer can be combined with the particle mixture and fed into an extruder. In accordance with the present disclosure, the plasticizer and particle mixture form a homogeneous gel-like material prior to leaving the extruder for forming polymer articles with little to no impurities.

In one embodiment, elongated articles, such as porous films, are formed during the gel spinning or extruding process and used as a separator in a battery.

During the process, at least a portion of the plasticizer is removed from the final product. The plasticizer removal process may occur due to evaporation when a relatively volatile plasticizer is used. Otherwise, an extraction liquid can be used to remove the plasticizer. The extraction liquid may comprise, for instance, a hydrocarbon solvent. One example of the extraction liquid, for instance, is dichloromethane. Other extraction liquids include acetone, chloroform, an alkane, hexene, heptene, an alcohol, or mixtures thereof.

If desired, the resulting polymer article can be stretched at an elevated temperature below the melting point of the polyethylene polymer to increase strength and modulus. Suitable temperatures for stretching are in the range of from about ambient temperature to about 155 °C. The draw ratios can generally be greater than about 4, such as greater than about 6, such as greater than about 8, such as greater than about 10, such as greater than about 15, such as greater than about 20, such as greater than about 25, such as greater than about 30. In certain embodiments, the draw ratio can be greater than about 50, such as greater than about 100, such as greater than about 110, such as greater than about 120, such as greater than about 130, such as greater than about 140, such as greater than about 150. Draw ratios are generally less than about 1,000, such as less than about 800, such as less than about 600, such as less than about 400. In one embodiment, lower draw ratios are used such as from about 4 to about 10. The polymer article can be uniaxially stretched or biaxially stretched.

Porous membranes made according to the present disclosure have sufficient strength such that they can be incorporated into an energy storage device, such as a battery, as a single layer polymer membrane. The single layer polymer membrane, however, may also include a coating. The coating can be an inorganic coating made from, for instance, aluminum oxide or a titanium oxide. Alternatively, the single layer polymer membrane may also include a polymeric coating. The coating can provide increased thermal resistance.

Porous membranes or films made according to the present disclosure can generally have a thickness of greater than about 3 microns, such as greater than about 4 microns, such as greater than about 5 microns, such as greater than about 6 microns, such as greater than about 7 microns, such as greater than about 8 microns, such as greater than about 9 microns. The thickness of the membranes or films is generally less than about 25 microns, such as less than about 16 microns, such as less than about 14 microns, such as less than about 12 microns, such as less than about 10 microns, such as less than about 8 microns, such as less than about 6 microns, such as less than about 5 microns.

Membranes or films made according to the present disclosure can have excellent physical properties. For example, membranes or films having a porosity of from about 25% to about 60%, such as from about 35% to about 55%, can have a puncture strength of greater than about 800 mN/micron, such as greater than about 1,200 mN/micron, such as greater than about 1,400 mN/micron, such as greater than about 1,475 mN/micron, such as greater than about 1,500 mN/micron, such as greater than about 1,525 mN/micron, such as greater than about 1,550 mN/micron, such as greater than about 1,575 mN/micron, such as greater than about 1,600 mN/micron, such as greater than about 1,625 mN/micron, such as greater than about 1,650 mN/micron, and generally less than about 3,000 mN/micron. The pin strength can be greater than about 200 gf/g/cm², such as greater than about 250 gf/g/cm², such as greater than about 252 gf/g/cm², such as greater than about 254 gf/g/cm², such as greater than about 256 gf/g/cm², such as greater than about 258 gf/g/cm², such as greater than about 260 gf/g/cm², such as greater than about 262 gf/g/cm², and generally less than about 300 gf/g/cm².

At a membrane or film porosity of from about 39% to about 50%, the membrane or film can have a puncture strength of greater than about 300 mN/micron, such as greater than about 340 mN/micron, such as greater than about 350 mN/micron, such as greater than about 360 mN/micron, such as greater than about 370 mN/micron, such as greater than about 380 mN/micron, such as greater than about 390 mN/micron, such as greater than about 400 mN/micron, and generally less than about 600 mN/micron and can have a pin strength of greater than about 60 gf/g/cm², such as greater than about 65 gf/g/cm², such as greater than about 72 gf/g/cm², such as greater than about 74 gf/g/cm², such as greater than about 76 gf/g/cm², such as greater than about 78 gf/g/cm², such as greater than about 80 gf/g/cm², such as greater than about 82 gf/g/cm², and generally less than about 150 gf/g/cm².

Membranes or films made according to the present disclosure can also have excellent tensile strength properties in either the machine direction or the cross-machine direction. For instance, in either direction, the membrane or film can have a tensile strength of greater than about 100 MPa, such as greater than about 125 MPa, such as greater than about 140 MPa, such as greater than about 150 MPa, such as greater than about 160 MPa, such as greater than about 162 MPa, such as greater than about 164 MPa, such as greater than about 166 MPa, such as greater than about 168 MPa, such as greater than about 170 MPa, and generally less than about 250 MPa.

Polymer membranes or films made according to the present disclosure can have a Gurley permeability of greater than about 50 sec/100 mL, such as greater than about 70 sec/100 mL, such as greater than about 105 sec/100 mL, such as greater than about 150 sec/100 mL, such as greater than about 200 sec/100 mL, such as greater than about 225 sec/100 mL, such as greater than about 250 sec/100 mL, such as greater than about 275 sec/100 mL, such as greater than about 300 sec/100 mL, such as greater than about 325 sec/100 mL, such as greater than about 350 sec/100 mL, such as greater than about 375 sec/100 mL, such as greater than about 400 sec/100 mL, such as greater than about 425 sec/100 mL, such as greater than about 450 sec/100 mL, such as greater than about 475 sec/100 mL, such as greater than about 500 sec/100 mL, such as greater than about 525 sec/100 mL, such as greater than about 550 sec/100 mL, such as greater than about 575 sec/100 mL, such as greater than about 600 sec/100 mL, and generally less than about 1,000 sec/100 mL.

An electrolyte is also contained within the energy storage device and is in contact with the anode, with the cathode, and with the separator. When the anode, cathode, and separator all contain a high density polyethylene polymer, an electrolyte can be selected that is compatible with the polymer for producing efficiencies not only in terms of mechanical properties but also in terms of electrical properties.

In one embodiment, present battery uses a suitable lithium-containing electrolyte. For example, a lithium salt, and a solvent, such as a non-aqueous or organic solvent, or fluorinated organic solvent. Generally, the lithium salt includes an anion that is redox stable. In some embodiments, the anion can be monovalent. In some embodiments, a lithium salt can be selected from hexafluorophosphate (LiPFe), lithium tetrafluoroborate (LiBF4), lithium perchlorate (LiClC), lithium bis(trifluoromethansulfonyl)imide (LiN(SO2CFs)2), lithium trifluoromethansulfonate (USO3CF3), lithium bis(oxalate) borate (LiBOB) and combinations thereof. In some embodiments, the electrolyte can include a quaternary ammonium cation and an anion selected from the group consisting of hexafluorophosphate, tetrafluoroborate and iodide. In some embodiments, the salt concentration can be about 0.1 mol/L (M) to about 5 M, about 0.2 M to about 3 M, or about 0.3 M to about 2 M. In further embodiments, the salt concentration of the electrolyte can be about 0.7 M to about 1 M. In certain embodiments, the salt concentration of the electrolyte can be about 0.2 M, about 0.3 M, about 0.4 M, about 0.5 M, about 0.6 M, about 0.7 M, about 0.8 M, about 0.9 M, about 1 M, about 1.1 M, about 1.2 M, or any range of values therebetween.

In some embodiments, electrolytes of the present high voltage lithium-ion secondary battery invention include a liquid solvent. In further embodiments, the solvent can be an organic solvent. In some embodiments, a solvent can include one or more functional groups selected from carbonates, ethers and/or esters. In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), methyl (2,2,2-trifluoroethyl) carbonate (FEMC) and combinations thereof, or acyclic carbonates such as, for example, dimethyl carbonate (DMC), diethyl carbonate (DEC), ethyl methyl carbonate (EMC), and combinations thereof. In certain embodiments, the electrolyte can comprise Li PF6, and one or more carbonates. An example organic solvent electrolyte includes the electrolyte known in this field as “Gen 2” electrolyte, which is 1.0 M LiPFe in ethylene carbonate (EC) and ethylmethyl carbonate (EMC), EC:EMC ratio of 3:7 by weight. In a preferred embodiment, electrolyte for use in the present high voltage lithium-ion secondary battery invention is the fluorinated organic solvent electrolyte. For example, fluorinated electrolyte referred to as FEC-FEMC, which is 1 M LiPFe in fluoroethylene carbonate (FEC) and methyl (2,2,2-trifluoroethyl) carbonate (FEMC), having an FEC:FEMC ratio of 1:9 by volume.

In an alternative embodiment, the high density polyethylene micropowder of the present disclosure can be used to produce sintered products, such as pipette tips, biomedical filters and other porous substrates.

For instance, the resulting granular product of the present disclosure can be used to form porous articles through a sintering process. Porous articles may be formed by a free sintering process which involves introducing the polyethylene polymer powder described above into either a partially or totally confined space, e.g., a mold, and subjecting the molding powder to heat sufficient to cause the polyethylene particles to soften, expand and contact one another. Suitable processes include compression molding and casting. The mold can be made of steel, aluminum or other metals.

The mold can be heated in a convection oven, hydraulic press or infrared heater to a sintering temperature between about 140 °C and about 300 °C, such as between about 160 °C and about 300 °C, for example between about 170 °C and about 240 °C to sinter the polymer particles. The heating time and temperature vary and depend upon the mass of the mold and the geometry of the molded article. However, the heating time typically lies within the range of about 25 to about 100 minutes. During sintering, the surface of individual polymer particles fuse at their contact points forming a porous structure. Subsequently, the mold is cooled and the porous article removed. In general, a molding pressure is not required. However, in cases requiring porosity adjustment, a proportional low pressure can be applied to the powder.

Porous substrates made according to the present disclosure can have a porosity of greater than about 20%, such as greater than about 35%, such as greater than about 40%. The porosity is generally less than about 80%, such as less than about 60%, such as less than about 55%. Porosity can be determined according to DIN Test 66133. Average pore size which can also be determined according to Test DIN 66133 can generally be less than about 180 microns, such as less than about 150 microns, such as less than about 110 microns, such as less than about 90 microns, and greater than about 20 microns.

Porous substrates made according to the present disclosure can be used in numerous and diverse applications. Specific examples include wastewater aeration, capillary applications and filtration.

Capillary applications of the present porous sintered articles include writing instruments, such as highlighters, color sketch pens, permanent markers and erasable whiteboard markers. These make use of the capillary action of a porous nib to transport ink from a reservoir to a writing surface. Currently, porous nibs formed from ultra-high molecular weight polyethylene are frequently used for highlighters and color sketch pens, whereas permanent and whiteboard markers are generally produced from by polyester (polyethylene terephthalate), polyolefin hollow fibers and acrylic porous materials. The large pore size of the present sintered articles make them attractive for use in the capillary transport of the alcohol-based high-viscosity inks employed in permanent markers and white board markers.

Other filtration applications of the present porous sintered articles include medical fluid filtration, such as filtration of blood outside the human body, filtration to remove solids in chemical and pharmaceutical manufacturing processes, and filtration of hydraulic fluids to remove solid contaminants.

In still another embodiment, the polymer micropowder of the present disclosure can be used as an additive and compounded with various different thermoplastic polymers. For example, in one embodiment, the polymer micropowder of the present disclosure can be used as an anti-wear additive, compounded with one or more thermoplastic polymers, and molded into an article. The thermoplastic polymer, for instance, can comprise a polyoxymethylene polymer, a polyamide polymer, a polyester polymer, a liquid crystal polymer, a polyphenylene sulfide polymer, a polyolefin polymer, or mixtures thereof. The polymer micropowder of the present disclosure can be combined directly with one or more thermoplastic polymers or can be added as a masterbatch where the polymer micropowder is first compounded with a thermoplastic polymer.

When used as an additive, the one or more thermoplastic polymers can form a matrix into which the polymer micropowder is dispersed. The one or more thermoplastic polymers, for instance, can be present in the polymer composition in an amount greater than about 40% by weight, such as in an amount greater than about 50% by weight, such as in an amount greater than about 60% by weight, such as in an amount greater than about 70% by weight, such as in an amount greater than about 80% by weight, and in an amount less than about 99% by weight, such as in an amount less than about 95% by weight. The polymer micropowder can be added to the polymer composition in an amount greater than about 0.1% by weight, such as in an amount greater than about 0.5% by weight, such as in an amount greater than about 1% by weight, such as in an amount greater than about 1.5% by weight, such as in an amount greater than about 2% by weight, and in an amount less than about 10% by weight, such as in an amount less than about 8% by weight, such as in an amount less than about 6% by weight, such as in an amount less than about 4% by weight, such as in an amount less than about 2% by weight.

The polymer composition containing the polymer micropowder can be formed into all different types of products and articles. The polymer composition, for instance, can be extruded into a film or molded into an article using injection molding or the like.

In still another embodiment, the polymer micropowder of the present disclosure can be incorporated into a lubricant composition. The lubricant composition, for instance, can be an oil-based or a grease-based composition. In the past, these compositions typically contained polytetrafluoroethylene particles. The polymer micropowder of the present disclosure, however, can be used to replace the polytetrafluoroethylene particles.

The lubricant composition, for instance, can comprise any suitable grease. The grease, for instance, can be designed to provide long-term lubrication, especially in high friction and high load applications. In one aspect, the polymer micropowder can be added to a general purpose grease that may be used for automotive, marine and household lubrication. The polymer micropowder can also be added to a high temperature grease designed for applications requiring heat resistance, such as for use in ovens and industrial machinery. The polymer micropowder can also be used in a grease for bearings and bushings to reduce wear and friction.

Lubricating compositions according to the present disclosure containing the polymer micropowder can contain a base oil or grease. The base oil can comprise mineral oil, a synthetic oil, or a bio-based oil. The synthetic oil, for instance, may comprise a polyalphaolefin, an ester, a silicone, or the like.

Greases are generally formed by thickening a base oil. For instance, a grease can be formed from any of the base oils described above. In one aspect, a base oil is combined with a thickener to produce a grease. The grease can contain a lithium or lithium complex, a calcium sulfonate, an aluminum complex, a polyurea, or the like. The polymer micropowder of the present disclosure can be incorporated into a lubricating composition in an amount greater than about 0.01% by weight, such as in an amount greater than about 0.1% by weight, such as in an amount greater than about 0.5% by weight, and in an amount less than about 10% by weight, such as in an amount less than about 5% by weight, such as in an amount less than about 2% by weight.

The present disclosure may be better understood with reference to the following example.

### Example No. 1

Multi-nodal polyethylene particles were produced. The multi-nodal particles were then subjected to testing to determine average nodule size. One of the samples was then fed through a grinding process to produce a polymer micropowder in accordance with the present disclosure.

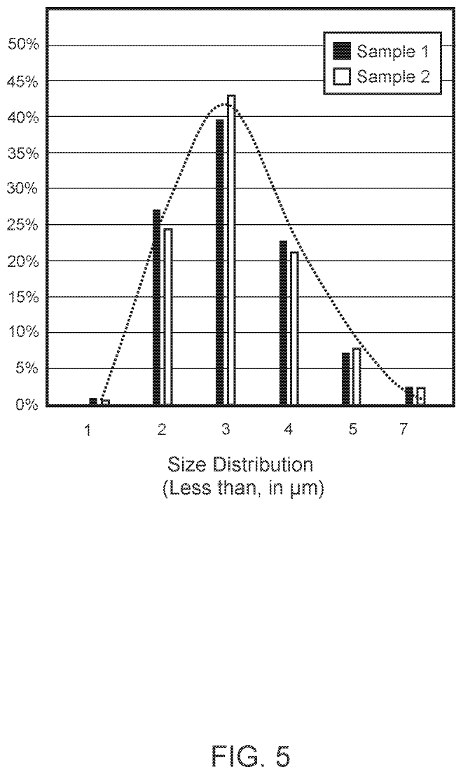

Two different multi-nodal polyethylene particle compositions were produced. Sample No. 1 was produced having an average molecular weight of about 200,000 g/mol. Sample No. 2, on the other hand, was produced having an average molecular weight of about 2,000,000 g/mol. Using an SEM microscope, the sizes of the nodes were determined in order to calculate an average nodule size. The nodule size distribution is illustrated in FIG. 5. As shown, the average nodule size was approximately 3 microns for both samples. Even though the samples differed in molecular weight, both samples had very similar nodule size distributions.

Sample No. 2 was then subjected to a grinding process. Grinding was conducted in an AFG jet mill commercially available from the Hosokawa Alpine Group.

After grinding, the following results were obtained:

| Sample No. 2 | After Grinding |
|---|---|
| Particle size (D50) (microns) | 9 |
| determined by laser scattering | |
| 10^{th} percentile particle size | 2 |
| 90^{th} percentile particle size | 16 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A polymer micropowder comprising:
polymer particles having a median particle size (D50) of less than about 9.5 microns, the polymer particles comprising a high density polyethylene polymer, the high density polyethylene polymer having an average molecular weight of greater than about 200,000 g/mol, the polymer particles displaying a 10th percentile particle size of from about 0.5 microns to about 3 microns and a 90th percentile particle size of from about 12 microns to about 25 microns.

2. A polymer micropowder as defined in claim 1, wherein the polymer particles have a median particle size (D50) of greater than about 2 microns.

3. A polymer micropowder as defined in claim 1, wherein the polymer particles have a median particle size (D50) of greater than about 4 microns.

4. A polymer micropowder as defined in claim 1, wherein the high density polyethylene polymer has an average molecular weight of greater than about 300,000 g/mol.

5. A polymer micropowder as defined in claim 1, wherein the polymer particles comprise ground particles.

6. A polymer micropowder as defined in claim 1, wherein the polymer particles comprise remnants of nodes separated from multi-lobal-shaped polymer particles.

7. A polymer micropowder as defined in claim 1, wherein the high density polyethylene polymer has a melting temperature of less than about 135.5 °C.

8. A polymer micropowder as defined in claim 1, wherein the high density polyethylene polymer displays a bulk density of less than 0.39 g/cm3.

9. A polymer micropowder as defined in claim 1, wherein the polymer particles display a 10th percentile particle size of from about 1.5 microns to about 2.5 microns.

10. A polymer micropowder as defined in claim 1, wherein the polymer particles display a 90th percentile particle size of from about 12 microns to about 22 microns.

11. A molded article comprising the polymer micropowder as defined in claim 1.

12. A molded article as defined in claim 11, wherein the molded article comprises a porous membrane.

13. A molded article as defined in claim 12, wherein the porous membrane has a thickness of from about 3 microns to about 25 microns, has a porosity of from about 25% to about 60%, and displays a Gurley permeability of from about 50 mL/min to about 500 mL/min.

14. An energy storage device comprising an anode, a cathode, and a separator positioned between the anode and the cathode, the separator comprising the porous membrane as defined in claim 12.

15. An electrode comprising a film comprising a network of an active material held together by a binder, the binder comprising the polymer micropowder of claim 1.

16. A high density polyethylene particle composition comprising:
high density polyethylene particles having a multi-nodal configuration, the high density polyethylene particles having a median particle size (D50) of from about 20 microns to about 500 microns, the multi-nodal particles including nodes on the surface of each particle having an average nodule size of from about 0.5 microns to about 5 microns.

17. A high density polyethylene particle composition as defined in claim 16, wherein the high density polyethylene particles have a median particle size (D50) of from about 40 microns to about 250 microns.

18. A high density polyethylene particle composition as defined in claim 16, wherein the nodes have an average nodule size of from about 2 microns to about 5 microns.

19. A high density polyethylene particle composition as defined in claim 16, wherein all the nodules on the particles have a particle size of less than about 15 microns.

20-24. (canceled)

25. A polymer composition comprising:
a thermoplastic polymer present in the polymer composition in an amount of at least about 40% by weight, the thermoplastic polymer comprising a polyoxymethylene polymer, a polyester polymer, a polyamide polymer, a liquid crystal polymer, a phenylene sulfide polymer, a polyolefin polymer, or mixtures thereof; and
a wear-reducing agent blended with the thermoplastic polymer, the wear-reducing agent comprising the polymer micropowder as defined in claim 1.

26. A lubricant composition comprising:
a lubricating matrix made from a base oil or a grease; and
a polymer micropowder dispersed within the base oil or grease, the polymer micropowder comprising polymer particles having a median particle size (D50) of less than about 9.5 microns, the polymer particles comprising a high density polyethylene polymer, the high density polyethylene polymer having an average molecular weight of greater than about 200,000 g/mol, the polymer particles displaying a 10th percentile particle size of from about 0.5 microns to about 3 microns and a 90th percentile particle size of from about 12 microns to about 25 microns.

27. (canceled)

28. A high density polyethylene particle composition comprising:
high density polyethylene particles having a multi-nodal configuration, the high density polyethylene particles having a median particle size (D50) of from about 20 microns to about 500 microns, the multi-nodal particles including nodes on the surface of each particle having an average nodule size of from about 0.5 microns to about 5 microns.

29-39. (canceled)
